(19) United States
(12) Patent Application Publication
(10) Pub. No.: US 2024/0419979 A1
(43) Pub. Date: Dec. 19, 2024

(54) TECHNIQUES FOR GENERATING INITIALIZATIONS FOR PARALLEL OPTIMIZERS

(71) Applicant: NVIDIA CORPORATION, Santa Clara, CA (US)

(72) Inventors: Peter KARKUS, Zurich (CH); Tong CHE, San Jose, CA (US); Christopher MAES, San Jose, CA (US); Shie MANNOR, Haifa (IL); Marco PAVONE, Stanford, CA (US); Yunfei SHI, Santa Clara, CA (US); Heng YANG, Cambridge, MA (US)

(21) Appl. No.: 18/416,828

(22) Filed: Jan. 18, 2024

Related U.S. Application Data
(60) Provisional application No. 63/508,488, filed on Jun. 15, 2023.

(51) Int. Cl. G06N 3/092

(52) U.S. Cl. CPC G06N 3/092

(57) ABSTRACT

One embodiment of a method for controlling a system includes generating a plurality of initializations using a trained machine learning model, performing a plurality of instances of an iterative technique based on the plurality of initializations to generate a plurality of results, generating a control signal based on one or more results included in the plurality of results, and transmitting the control signal to the system to cause the system to perform one or more operations.

### CROSS-REFERENCE TO RELATED APPLICATIONS

This application claims priority benefit of the United States Provisional Patent Application titled, “TECHNIQUES FOR PREDICTING INITIALIZATIONS FOR OPTIMIZATION ALGORITHMS,” filed on Jun. 15, 2023, and having Ser. No. 63/508,488. The subject matter of this related application is hereby incorporated herein by reference.

### BACKGROUND

### Technical Field

Embodiments of the present disclosure relate generally to computer science and artificial intelligence and, more specifically, to techniques for generating initializations for parallel optimizers.

### Description of the Related Art

Iterative optimization techniques are mathematical procedures for computing solutions to problems over a number of iterations. One example of an iterative optimization technique is the model predictive control (MPC) technique, which calculates control actions that minimize a cost function while satisfying a set of constraints. The MPC technique can be used to control various systems, such as autonomous vehicles and robots.

Conventional iterative optimization techniques can be highly sensitive to initializations, which are the starting points used by the iterative optimization techniques. Without a good initialization, an iterative optimization technique can either take a very long time to converge to a solution or converge to a local optimum that is significantly different from the overall optimum solution.

One conventional approach for selecting an initialization for an iterative optimization technique is to use a previously generated solution as the initialization. For example, in the case of an autonomous vehicle, the MPC technique could be initialized using a previously generated control action for controlling the autonomous vehicle. However, when the environment around the autonomous vehicle changes, such as when a traffic light turns to red from green, initializing the MPC technique using a previously generated control action from when the traffic light was green can cause the MPC technique to be unable to converge to a solution in a given amount of time or to generate a new control action that is incorrect for controlling the autonomous vehicle when the traffic light is red. Accordingly, using a previously generated solution to initialize an iterative optimization technique can cause the iterative optimization technique to generate an undesirable solution.

As the foregoing illustrates, what is needed in the art are more effective techniques for initializing iterative optimization techniques.

### SUMMARY

One embodiment of the present disclosure sets forth a computer-implemented method for controlling a system. The method includes generating a plurality of initializations using a trained machine learning model. The method further includes performing a plurality of instances of an iterative technique based on the plurality of initializations to generate a plurality of results. The method also includes generating a control signal based on one or more results included in the plurality of results. In addition, the method includes transmitting the control signal to the system to cause the system to perform one or more operations.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques generate multiple initializations that can be used to initialize multiple optimizers that execute in parallel. The multiple optimizers generate multiple optimization results, where one or more of those optimization results are typically improved relative to the optimization result generated by a single optimizer that is initialized using prior art approaches. Further, at least one of the improved optimization results can be selected to generate a control signal for controlling an autonomous vehicle, robot, or other system in a more correct manner relative to a control signal that can typically be generated using the optimization result of a single optimizer. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the computing device FIG. 1, according to various embodiments;

FIG. 3 is a block diagram of a parallel processing unit included in the parallel processing subsystem of FIG. 2, according to various embodiments;

FIG. 4 is a block diagram of a general processing cluster included in the parallel processing unit of FIG. 3, according to various embodiments;

FIG. 5 is a more detailed illustration of the control application of FIG. 1, according to various embodiments;

FIG. 6 is a flow diagram of method steps for training an initialization model via reinforcement learning, according to various embodiments;

FIG. 7 is a flow diagram of method steps for training an initialization model via supervised learning, according to various embodiments;

FIG. 8 is a flow diagram of method steps for training an initialization model via a combination of supervised learning and reinforcement learning, according to various embodiments; and

FIG. 9 is a flow diagram of method steps for generating a control signal using a trained initialization model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating initializations for parallel optimizers. In some embodiments, a control application generates multiple initializations for an iterative optimization technique using a trained initialization model. The initialization model is a machine learning model that is trained to generate initializations for initializing the iterative optimization technique. The control application performs multiple instances of the iterative optimization technique in parallel, beginning from the multiple initializations, to generate multiple optimization results. Then, the control application computes a cost associated with each of the multiple optimization results, and the control application selects one of the optimization results based on the computed costs. Thereafter, the control application generates a control signal from the selected optimization result, and the control application transmits the control signal to control a system, such as an autonomous vehicle, a robot, a power plant, or the like.

In some embodiments, the initialization model can be trained via reinforcement learning, supervised learning, or a combination thereof. During reinforcement learning, the initialization model is used to generate initializations, an iterative optimization technique is performed using the initializations to generate optimization results, a reward is computed based on the optimization results, and parameters of the initialization model are updated based on the reward. During supervised learning, an iterative optimization technique is used to generate optimization results, and the optimization results are included in training data that is used to train the initialization model. During the combination of supervised and reinforcement learning, the initialization model is first trained using supervised learning to initialize the initialization model, and the training of the initialization model then switches to reinforcement learning.

The techniques for using a trained initialization model to generate initializations for parallel optimizers have many real-world applications. For example, those techniques could be used to generate initializations for parallel optimizers that perform an iterative optimization technique used to control an autonomous vehicle. As another example, those techniques could be used to generate initializations for parallel optimizers that perform an iterative optimization technique used to control a robot in a factory, warehouse, or other industrial environment. As a further example, those techniques could be used to generate initializations for parallel optimizers that perform an iterative optimization technique used to control a power plant.

The above examples are not in any way intended to be limiting. As persons skilled in the art will appreciate, as a general matter, the techniques for generating initializations for parallel optimizers described herein can be implemented in any suitable application.

### System Overview

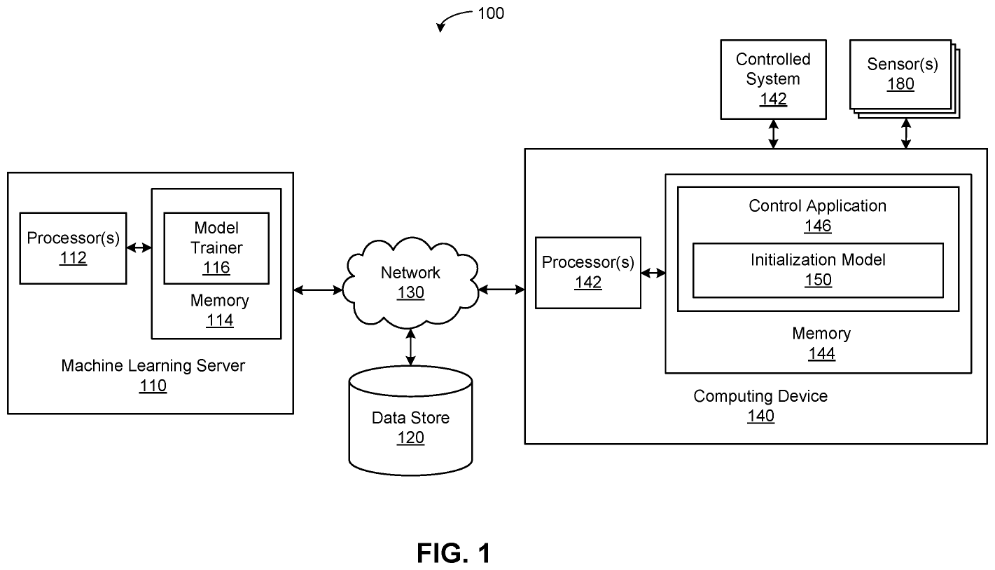

FIG. 1 illustrates a block diagram of a computer-based system 100 configured to implement one or more aspects of at least one embodiment. As shown, the system 100 includes a machine learning server 110, a data store 120, and a computing device 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor 112 receives user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

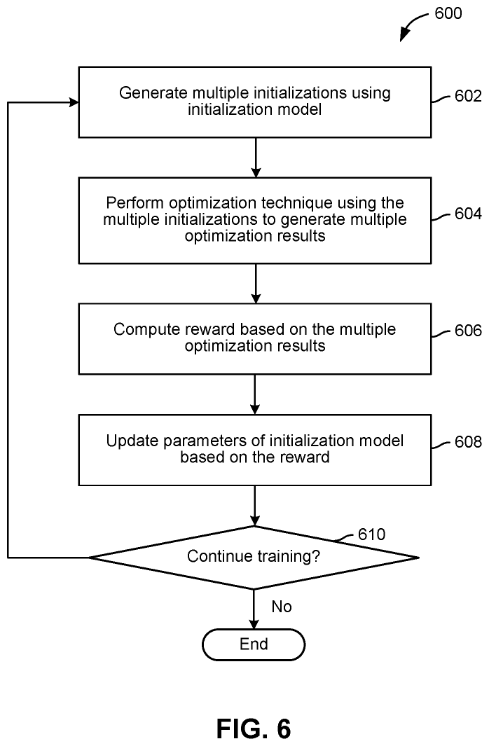

In some embodiments, the model trainer 116 is configured to train one or more machine learning models, including an initialization model 150 that is trained to generate initializations for an iterative optimization technique. Techniques that the model trainer 116 can employ to train the machine learning model(s) are discussed in greater detail below in conjunction with FIGS. 6-8. Training data and/or trained (or deployed) machine learning models, including the initialization model 150, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

As shown, a control application 146 that uses the initialization model 150 is stored in a system memory 144, and executes on a processor 142, of the computing device 140. Once trained, the initialization model 150 can be deployed, such as via control application 146. Illustratively, given an input, such as a predefined initialization and state data acquired via one or more sensors 180 (e.g., an accelerometer, steering wheel sensor, etc. in the case of an autonomous vehicle), the initialization model 150 can process the input to generate multiple initializations for initializing an iterative optimization technique to generate multiple optimization results, one of which can be selected for use in controlling a controlled system 142. For example, the controlled system 142 could be an autonomous vehicle, a robot, a power plant, or the like.

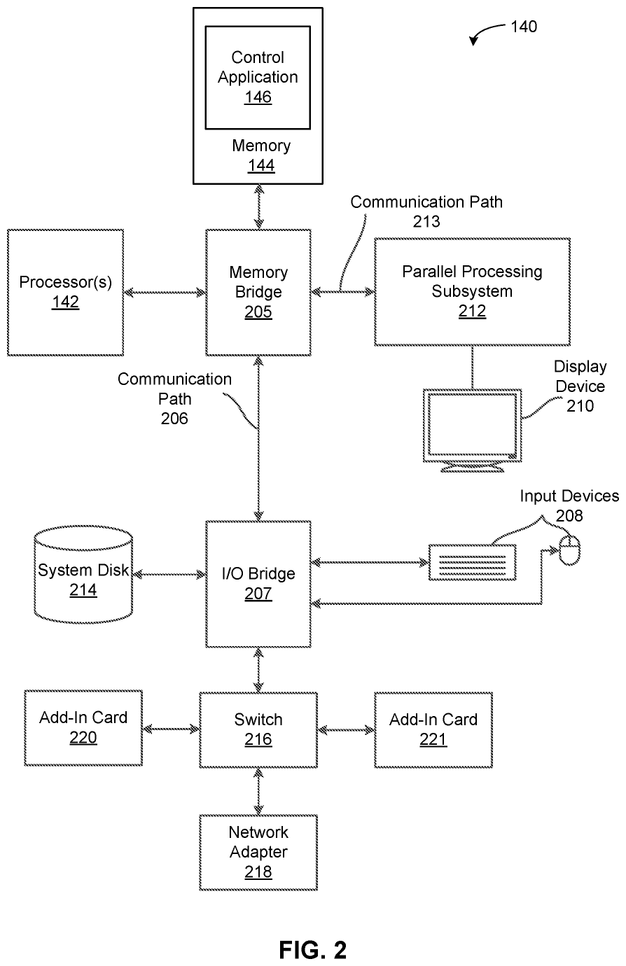

FIG. 2 is a block diagram illustrating the computing device 140 of FIG. 1 in greater detail, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, the machine learning server 110 can include one or more similar components as the computing device 140.

In various embodiments, the computing device 140 includes, without limitation, the processor(s) 142 and the memory(ies) 144 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, computing device 140 may not include input devices 208, but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the computing device 140, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 144 includes at least one device driver configured to manage the processing operations of the one or more PPUs within parallel processing subsystem 212. In addition, the system memory 144 includes the model trainer 116. Although described herein primarily with respect to the model trainer 116, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, the processor(s) 142 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, system memory 144 could be connected to the processor(s) 142 directly rather than through memory bridge 205, and other devices may communicate with system memory 144 via memory bridge 205 and processor 142. In other embodiments, parallel processing subsystem 212 may be connected to I/O bridge 207 or directly to processor 142, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

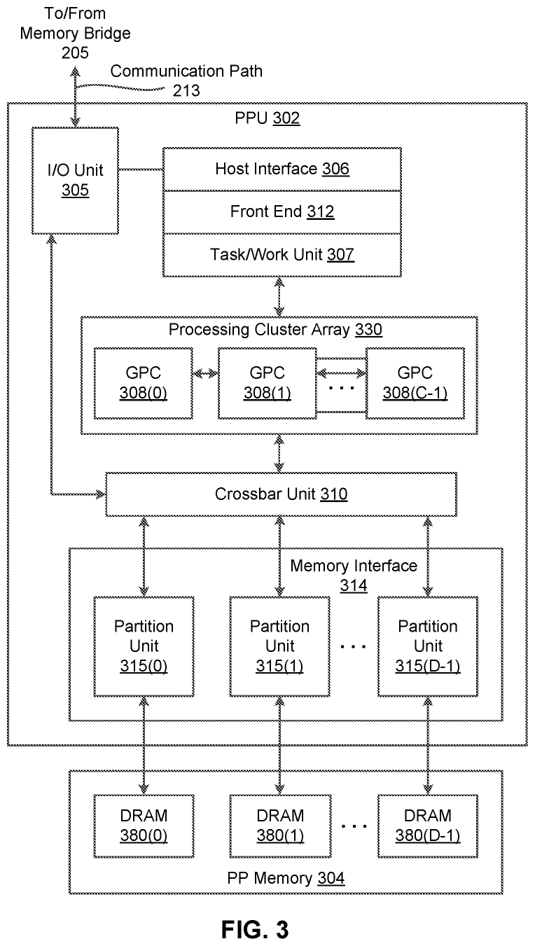

FIG. 3 is a block diagram of a parallel processing unit (PPU) 302 included in the parallel processing subsystem 112 of FIG. 2, according to various embodiments. Although FIG. 3 depicts one PPU 302, as indicated above, parallel processing subsystem 112 may include any number of PPUs 302. As shown, PPU 302 is coupled to a local parallel processing (PP) memory 304. PPU 302 and PP memory 304 may be implemented using one or more integrated circuit devices, such as programmable processors, application specific integrated circuits (ASICs), or memory devices, or in any other technically feasible fashion.

In some embodiments, PPU 302 comprises a GPU that may be configured to implement a graphics rendering pipeline to perform various operations related to generating pixel data based on graphics data supplied by processor(s) 142 and/or system memory 144. When processing graphics data, PP memory 304 can be used as graphics memory that stores one or more conventional frame buffers and, if needed, one or more other render targets as well. Among other things, PP memory 304 may be used to store and update pixel data and deliver final pixel data or display frames to an optional display device 110 for display. In some embodiments, PPU 302 also may be configured for general-purpose processing and compute operations. In some embodiments, computing device 140 may be a server machine in a cloud computing environment. In such embodiments, computing device 140 may not have a display device 110. Instead, computing device 140 may generate equivalent output information by transmitting commands in the form of messages over a network via the network adapter 118.

In some embodiments, processor(s) 142 is the master processor of computing device 140, controlling and coordinating operations of other system components. In one embodiment, processor(s) 142 issues commands that control the operation of PPU 302. In some embodiments, processor(s) 142 writes a stream of commands for PPU 302 to a data structure (not explicitly shown in either FIG. 2 or FIG. 3) that may be located in system memory 144, PP memory 304, or another storage location accessible to both processor(s) 142 and PPU 302. A pointer to the data structure is written to a command queue, also referred to herein as a pushbuffer, to initiate processing of the stream of commands in the data structure. In one embodiment, the PPU 302 reads command streams from the command queue and then executes commands asynchronously relative to the operation of processor(s) 142. In embodiments where multiple pushbuffers are generated, execution priorities may be specified for each pushbuffer by an application program via device driver to control scheduling of the different pushbuffers.

In one embodiment, PPU 302 includes an I/O (input/output) unit 305 that communicates with the rest of computing device 140 via the communication path 113 and memory bridge 105. In one embodiment, I/O unit 305 generates packets (or other signals) for transmission on communication path 113 and also receives all incoming packets (or other signals) from communication path 113, directing the incoming packets to appropriate components of PPU 302. For example, commands related to processing tasks may be directed to a host interface 306, while commands related to memory operations (e.g., reading from or writing to PP memory 304) may be directed to a crossbar unit 310. In one embodiment, host interface 306 reads each command queue and transmits the command stream stored in the command queue to a front end 312.

As mentioned above in conjunction with FIG. 2, the connection of PPU 302 to the rest of computing device 140 may be varied. In some embodiments, parallel processing subsystem 112, which includes at least one PPU 302, is implemented as an add-in card that can be inserted into an expansion slot of computing device 140. In other embodiments, PPU 302 can be integrated on a single chip with a bus bridge, such as memory bridge 105 or I/O bridge 107. Again, in still other embodiments, some or all of the elements of PPU 302 may be included along with processor(s) 142 in a single integrated circuit or system of chip (SoC).

In one embodiment, front end 312 transmits processing tasks received from host interface 306 to a work distribution unit (not shown) within task/work unit 307. In one embodiment, the work distribution unit receives pointers to processing tasks that are encoded as task metadata (TMD) and stored in memory. The pointers to TMDs are included in a command stream that is stored as a command queue and received by the front end unit 312 from the host interface 306. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 307 receives tasks from the front end 312 and ensures that GPCs 308 are configured to a valid state before the processing task specified by each one of the TMDs is initiated. A priority may be specified for each TMD that is used to schedule the execution of the processing task. Processing tasks also may be received from the processing cluster array 330. Optionally, the TMD may include a parameter that controls whether the TMD is added to the head or the tail of a list of processing tasks (or to a list of pointers to the processing tasks), thereby providing another level of control over execution priority.

In one embodiment, PPU 302 implements a highly parallel processing architecture based on a processing cluster array 330 that includes a set of C general processing clusters (GPCs) 308, where C≥1. Each GPC 308 is capable of executing a large number (e.g., hundreds or thousands) of threads concurrently, where each thread is an instance of a program. In various applications, different GPCs 308 may be allocated for processing different types of programs or for performing different types of computations. The allocation of GPCs 308 may vary depending on the workload arising for each type of program or computation.

In one embodiment, memory interface 314 includes a set of D of partition units 315, where D≥1. Each partition unit 315 is coupled to one or more dynamic random access memories (DRAMs) 320 residing within PPM memory 304. In some embodiments, the number of partition units 315 equals the number of DRAMs 320, and each partition unit 315 is coupled to a different DRAM 320. In other embodiments, the number of partition units 315 may be different than the number of DRAMs 320. Persons of ordinary skill in the art will appreciate that a DRAM 320 may be replaced with any other technically suitable storage device. In operation, various render targets, such as texture maps and frame buffers, may be stored across DRAMs 320, allowing partition units 315 to write portions of each render target in parallel to efficiently use the available bandwidth of PP memory 304.

In one embodiment, a given GPC 308 may process data to be written to any of the DRAMs 320 within PP memory 304. In one embodiment, crossbar unit 310 is configured to route the output of each GPC 308 to the input of any partition unit 315 or to any other GPC 308 for further processing. GPCs 308 communicate with memory interface 314 via crossbar unit 310 to read from or write to various DRAMs 320. In some embodiments, crossbar unit 310 has a connection to I/O unit 305, in addition to a connection to PP memory 304 via memory interface 314, thereby enabling the processing cores within the different GPCs 308 to communicate with system memory 144 or other memory not local to PPU 302. In the embodiment of FIG. 3, crossbar unit 310 is directly connected with I/O unit 305. In various embodiments, crossbar unit 310 may use virtual channels to separate traffic streams between the GPCs 308 and partition units 315.

In one embodiment, GPCs 308 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 302 is configured to transfer data from system memory 144 and/or PP memory 304 to one or more on-chip memory units, process the data, and write result data back to system memory 144 and/or PP memory 304. The result data may then be accessed by other system components, including processor(s) 142, another PPU 302 within parallel processing subsystem 112, or another parallel processing subsystem 112 within computing device 140.

In one embodiment, any number of PPUs 302 may be included in a parallel processing subsystem 112. For example, multiple PPUs 302 may be provided on a single add-in card, or multiple add-in cards may be connected to communication path 113, or one or more of PPUs 302 may be integrated into a bridge chip. PPUs 302 in a multi-PPU system may be identical to or different from one another. For example, different PPUs 302 might have different numbers of processing cores and/or different amounts of PP memory 304. In implementations where multiple PPUs 302 are present, those PPUs may be operated in parallel to process data at a higher throughput than is possible with a single PPU 302. Systems incorporating one or more PPUs 302 may be implemented in a variety of configurations and form factors, including, without limitation, desktops, laptops, handheld personal computers or other handheld devices, wearable devices, servers, workstations, game consoles, embedded systems, and the like.

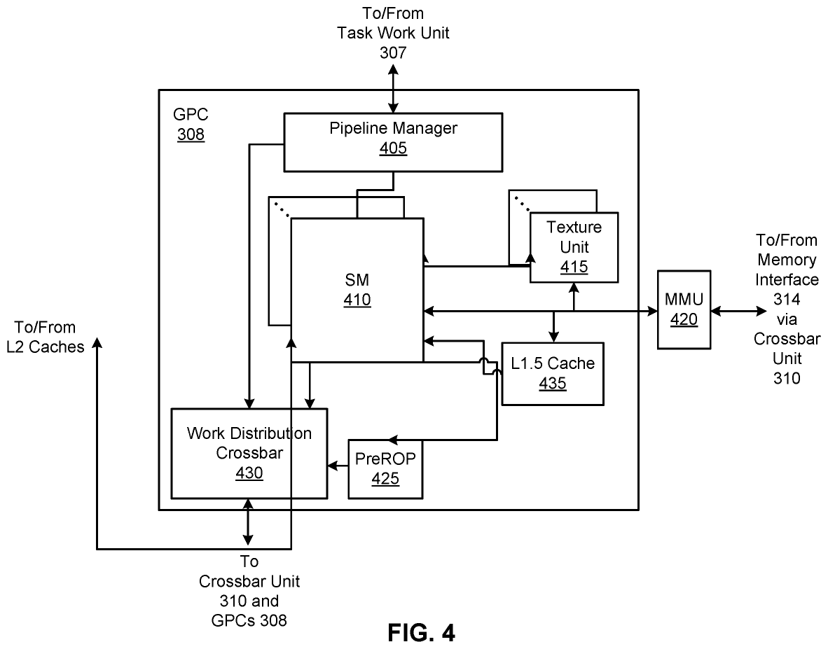

FIG. 4 is a block diagram of a general processing cluster (GPC) 208 included in the parallel processing unit (PPU) 202 of FIG. 3, according to various embodiments. As shown, the GPC 208 includes, without limitation, a pipeline manager 405, one or more texture units 415, a preROP unit 425, a work distribution crossbar 430, and an L1.5 cache 435.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 405 that distributes processing tasks received from a work distribution unit (not shown) within task/work unit 207 to one or more streaming multiprocessors (SMs) 410. Pipeline manager 405 may also be configured to control a work distribution crossbar 430 by specifying destinations for processed data output by SMs 410.

In various embodiments, GPC 208 includes a set of M of SMs 410, where M≥1. Also, each SM 410 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 410 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 410 is configured to process one or more thread groups. As used herein, a “thread group” or “warp” refers to a group of threads concurrently executing the same program on different input data, with one thread of the group being assigned to a different execution unit within an SM 410. A thread group may include fewer threads than the number of execution units within the SM 410, in which case some of the execution may be idle during cycles when that thread group is being processed. A thread group may also include more threads than the number of execution units within the SM 410, in which case processing may occur over consecutive clock cycles. Since each SM 410 can support up to G thread groups concurrently, it follows that up to G*M thread groups can be executing in GPC 208 at any given time.

Additionally, in one embodiment, a plurality of related thread groups may be active (in different phases of execution) at the same time within an SM 410. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 410, and m is the number of thread groups simultaneously active within the SM 410. In some embodiments, a single SM 410 may simultaneously support multiple CTAs, where such CTAs are at the granularity at which work is distributed to the SMs 410.

In one embodiment, each SM 410 contains a level one (L1) cache or uses space in a corresponding L1 cache outside of the SM 410 to support, among other things, load and store operations performed by the execution units. Each SM 410 also has access to level two (L2) caches (not shown) that are shared among all GPCs 208 in PPU 202. The L2 caches may be used to transfer data between threads. Finally, SMs 410 also have access to off-chip “global” memory, which may include PP memory 204 and/or system memory 144. It is to be understood that any memory external to PPU 202 may be used as global memory. Additionally, as shown in FIG. 4, a level one-point-five (L1.5) cache 435 may be included within GPC 208 and configured to receive and hold data requested from memory via memory interface 214 by SM 410. Such data may include, without limitation, instructions, uniform data, and constant data. In embodiments having multiple SMs 410 within GPC 208, the SMs 410 may beneficially share common instructions and data cached in L1.5 cache 435.

In one embodiment, each GPC 208 may have an associated memory management unit (MMU) 420 that is configured to map virtual addresses into physical addresses. In various embodiments, MMU 420 may reside either within GPC 208 or within the memory interface 214. The MMU 420 includes a set of page table entries (PTEs) used to map a virtual address to a physical address of a tile or memory page and optionally a cache line index. The MMU 420 may include address translation lookaside buffers (TLB) or caches that may reside within SMs 410, within one or more L1 caches, or within GPC 208.

In one embodiment, in graphics and compute applications, GPC 208 may be configured such that each SM 410 is coupled to a texture unit 415 for performing texture mapping operations, such as determining texture sample positions, reading texture data, and filtering texture data.

In one embodiment, each SM 410 transmits a processed task to work distribution crossbar 430 in order to provide the processed task to another GPC 208 for further processing or to store the processed task in an L2 cache (not shown), parallel processing memory 204, or system memory 144 via crossbar unit 210. In addition, a pre-raster operations (preROP) unit 425 is configured to receive data from SM 410, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 410, texture units 415, or preROP units 425, may be included within GPC 208. Further, as described above in conjunction with FIG. 3, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Generating Initializations for Parallel Optimizers

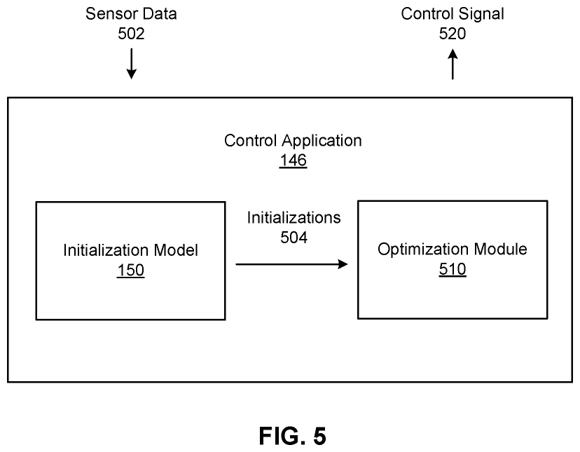

FIG. 5 is a more detailed illustration of the control application 146 of FIG. 1, according to various embodiments. As shown, the control application 146 includes the initialization model 150 and an optimization module 510. The initialization model 150 is a machine learning model, such as a neural network, that is trained to predict multiple initializations for an iterative optimization technique. The number of initializations that the initialization model 150 outputs can be a hyperparameter in some embodiments. Subsequent to training, the control application 146 uses the trained initialization model 150 to generate multiple initializations 504 for the iterative optimization technique. Then, the optimization module 510 performs multiple instances of the iterative optimization technique, beginning from the multiple initializations 504, to generate multiple optimization results. Any suitable iterative optimization technique can be performed, including iterative optimization techniques that begin from an initialization and optimize in continuous space (or even discrete optimizations). Examples of iterative optimization techniques include the model predictive control (MPC) technique, the linear-quadratic regulator (LQR) technique, gradient descent techniques (e.g., stochastic gradient descent), quasi-Newton methods (e.g., the Broyden-Fletcher-Goldfarb-Shanno (BFGS) technique and the limited memory BFGS (L-BFGS) technique), interior point techniques, Sequential Quadratic Programming, etc. In some embodiments, multiple instances of the iterative optimization technique can be performed in parallel, beginning from the multiple initializations 504, to generate the multiple optimization results. For example, multiple instances of the iterative optimization technique can be executed in parallel across different PPUs 302, different cores of a CPU, or the like. Advantageously, because multiple initializations are generated by performing multiple instances of the iterative optimization technique, at least one of the multiple instances of the iterative optimization technique may be able to converge to an initialization that is close to a global optimum, i.e., the probability of finding a global optimum and/or a good local optimizer is increased.

After generating the multiple optimization results, the optimization module 510 computes a cost associated with each optimization result and selects one of the optimization results based on the computed costs. Thereafter, the control application 146 can (1) generate a control signal 520 based on the selected optimization result, and (2) transmit the control signal to control a system (e.g., controlled system 142).

In some embodiments, the model trainer 116 can train the initialization model 150 via reinforcement learning, supervised learning, or a combination thereof. During reinforcement learning, the initialization model 150 is used to generate initializations, an iterative optimization technique is performed using the initializations to generate optimization results, a reward is computed based on the optimization results, and parameters of the initialization model 150 are updated based on the reward, as discussed in greater detail below in conjunction with FIG. 6. During supervised learning, an iterative optimization technique, which in some embodiments is a slower and/or more accurate technique, is used to generate optimization results, and the optimization results are included in training data that is used to train the initialization model 150. In some embodiments, the training can be performed in a manner that promotes mode diversity so that the trained initialization model 150 is capable of generating multiple different initializations. For example, in some embodiments, the training can employ a loss function that includes a loss term for the average distance between all pairs of output modes. Such a loss term helps ensure that initializations output by the initialization model 150 are different from each other by penalizing pairs of output modes being close to each other. As another example, in some embodiments, the training can maximize a likelihood only for the best predicted training mode under which the ground-truth optimization result has the highest likelihood. Such training helps diverse prediction modes to emerge by ensuring that the best initialization mode output by the initialization model 150 is a good prediction, without penalizing other initialization modes output by the initialization model 150 that are far from the ground-truth.

During a combination of supervised and reinforcement learning, the initialization model 150 is first trained using supervised learning to initialize the initialization model 150, and the initialized initialization model 150 is further trained using reinforcement learning. In some embodiments, training of the initialization model 150 can switch from supervised learning to reinforcement learning either gradually or at one state. It should be understood that reinforcement learning optimizes a more realistic objective than supervised learning. However, reinforcement learning requires performing the iterative optimization technique during training, making reinforcement learning more computationally expensive, as a general matter, than supervised learning. In addition, reinforcement learning can be less stable than supervised learning, meaning the machine learning model may fail to learn anything useful through reinforcement learning. Accordingly, the combination of supervised and reinforcement learning can reduce computational cost and increase stability by first training the initialization model 150 using supervised learning to initialize the initialization model 150, and then switching to reinforcement learning that optimizes the more realistic objective.

When the iterative optimization technique is the MPC technique, which is discussed herein as a reference example, the control problem is a finite-horizon nonlinear control problem with inequality constraints. In such a case, the dynamical system can be defined by xₜ₊₁=f_{d}(xₜ, uₜ). The problem instance is defined by an initial state x₀ and a set of parameters Θ that parameterize the constraints and the cost c(x, u; Θ), and the goal can be to find an optimal control sequence U*=[u₀*, . . . u_{T}*] that minimizes the cost c (x, u; Θ). In some embodiments, the MPC technique is used to compute an approximate solution to the control problem

$$\hat{u} = MPC ( {U}^{0} , I ; {x}_{0} , Θ ) , \qquad ( 1 )$$

given an initial control sequence U⁰ and a budget of I iterations. It will be assumed that the success of the MPC technique depends on the initial guess, i.e., the initialization of the MPC technique. Given the initial control sequence U⁰ and a given I, the MPC technique can only find a local optimum, which can in some cases be critically worse than the global optimum. For example, in the case of autonomous driving, it is common to initialize the MPC technique at time t with the planned control sequence from time t−1, but such an initialization can be a poor initialization if something has changed in the environment, such as a traffic light turning red, in which case the MPC technique can fail to find a solution reasonably close to the global optimum. It will further be assumed that the control problem requires generalization, i.e., the problem needs to be solved repeatedly for different inputs, and the optimal initialization of the iterative optimization technique (e.g., the MPC technique) differs for different input instances. It is also assumed that the model trainer 116 has access to a dataset D of problem instances and the (near) optimal solutions D={Θᵢ, x_{0,i}, Uᵢ*}, sampled from the target problem distribution. In addition, it is assumed that a model that generalizes near-perfectly to the distribution of task instances of interest is not easy to learn, so the entire iterative optimization technique cannot be replaced with a learned model.

Given such assumptions, the goal is to learn a machine learning model f_{θ} (e.g, initialization model 150), which can be a neural network model, that predicts a set of N initializations for the iterative optimization technique that 1) leads to faster overall inference time through choosing a lower number of initializations K, and/or 2) increases the probability of finding a better local or a global optimum when running N optimization problems (in parallel). In some embodiments, the machine learning model takes in the parameters that define the control task, and the machine learning model outputs parameters of a distribution over N initial control sequences,

$${\hat{U}}_{1 : N}^{0} ∼ {f}_{θ} ( {U}_{1 : N} \vert {x}_{0} , Θ ) . \qquad ( 2 )$$

In equation (2), f denotes a probability distribution. In practice, the machine learning model can be simplified. For example, in some embodiments, the machine learning model can simply output N control sequences, without sampling. The model f_{θ} can also parameterize a distribution, such as a Gaussian, from which N control sequences are sampled independently.

In the example of the MPC technique, the overall objective of learning can be expressed as

$${arg min}_{θ} \{ {𝔼}_{\{ {x}^{0} , Θ \} ∈ D} [ {𝔼}_{{\hat{U}}_{1 : N} ∼ {f}_{θ} ( {x}_{0} , Θ )} [ {min}_{n ∈ 1 : N} c ( MPC ( {\hat{U}}_{n} ; {x}_{0} , Θ ) ) ] ] \} . \qquad ( 3 )$$

However, the inner term of equation (3) is not differentiable. Therefore, a key design choice is an alternative proxy objective. Task-dependent design choices are input-output representation and the network architecture of the machine learning model.

To train the machine learning model (e.g., initialization model 150) via reinforcement learning, gradients of the objective function in equation (3) can be approximated through a score function estimation (also sometimes referred to as a “REINFORCE/policy gradient”). Doing so is intuitively similar to converting the problem into a one-step reinforcement learning task. Returning to the example of the MPC technique, let the score be denoted as

$$R ( {\hat{U}}_{1 : N} , {x}^{0} , Θ ) = {min}_{n ∈ 1 : N} c ( MPC ( {\hat{U}}_{n} ; {x}_{0} , Θ ) ) . \qquad ( 4 )$$

The gradient estimate is then

$${∇}_{θ} {𝔼}_{{\hat{U}}_{1 : N} ∼ {f}_{θ}} [ R ( {x}^{0} , Θ ) ] \approx {\sum }_{{\hat{U}}_{1 : N}^{i}} {∇}_{θ} {f}_{θ} ( {\hat{U}}_{1 : N}^{i} \vert {x}_{0} , Θ ) R ( {\hat{U}}_{1 : N} , {x}^{0} , Θ ) , \qquad ( 5 )$$

where Û_{1:N}ⁱ˜f_{θ}(Û_{1:N}|x₀, Θ) . The optimal θ will correspond to predicting an optimal set of diverse initializations for the MPC technique. It should be noted that score function estimators have a high variance, so training may not converge to an optimal θ in some cases. Further, reinforcement learning requires running the MPC technique (or other iterative optimization technique) for every output during training, which may be impractical compared to using precomputed training data, which is used in supervised learning.

As an alternative to, or in combination with, the reinforcement learning described above, the model trainer 116 can train a machine learning model (e.g., initialization model 150) via supervised learning using the optimal control sequence U*. For example, when the initialization model 150 is a Gaussian model, the model trainer 116 can train the initialization model 150 by minimizing the negative log-likelihood of the training data, i.e.,

$${arg min}_{θ} \{ {𝔼}_{\{ {x}^{0} , Θ , {U}^{*} \} ∈ D} ℓ ] , \\ where \qquad ( 6 )$$

$$ℓ = - log {f}_{θ} ( {U}^{*} \vert {x}_{0} , Θ ) . \qquad ( 7 )$$

Other types of initialization models, such as a multi-modal distribution (e.g., a Gaussian mixture model (GMM)) or a conditional variational autoencoder (CVAE), can be trained in a similar manner. In some embodiments, the initialization model 150 is trained in a manner that encourages mode diversity, so that the initialization model 150 is capable of generating multiple different initializations after training. For example, when the initialization model 150 is a GMM, the GMM can output K modes p=Σ_{k∈1:K}αₜheta(x₀, Θ; k)p_{θ}(U|x₀, Θ; k) and be trained using the loss function

$$ℓ = - log {\sum }_{k ∈ 1 : K} {α}_{θ , k} {p}_{θ , k} ( {U}^{*} \vert {x}_{0} , Θ ) . \qquad ( 8 )$$

In some embodiments, in order to encourage diversity so that the trained initialization model 150 can generate multiple initializations, the model trainer 116 can use a loss function with an additional loss term for the average distance between all pairs of output modes,

$$ℓ = - {\sum }_{k ∈ 1 : K} log {f}_{θ} ( {U}^{*} \vert {x}_{0} , Θ ; k ) + {\sum }_{k 1 ∈ 1 : K} {\sum }_{k 2 ∈ 1 : K} ‖ {μ}_{k 1 , θ} - {μ}_{k 2 , θ} ‖ , \qquad ( 9 )$$

μₖαₖ=1/K where is a mode of the GMM. Assume the GMM has fixed mixture parameters,. In some embodiments, the model trainer 116 can select the best predicted mode at training time, i.e., the mode under which the μₖαₖ=1/ground-truth control sequence has the highest likelihood, and only maximize the data likelihood for this mode

$$ℓ = - log {max}_{k ∈ 1 : K} {p}_{θ , k} ( {U}^{*} \vert {x}_{0} , Θ ) . \qquad ( 10 )$$

The intuition behind selecting the best predicted mode is the trained initialization model 150 only needs to output one initialization that is close to the ground truth, and the other modes are not penalized for being far from the ground truth.

FIG. 6 is a flow diagram of method steps for training an initialization model via reinforcement learning, according to various embodiments. Although the method steps are described in conjunction with the systems of FIGS. 1-5, persons skilled in the art will understand that any system configured to perform the method steps in any order falls within the scope of the present embodiments.

As shown, a method 600 begins at step 602, where the model trainer 116 generates multiple initializations using the initialization model 150 during training of the initialization model 150. In some embodiments, the multiple initializations can be generated by feeding required inputs into the initialization model 150, which in turn outputs the multiple initializations. Returning to the autonomous vehicle example, the multiple initializations can be generated by inputting states of the autonomous vehicle and a previous control action into the initialization model 150 that outputs the multiple initializations.

At step 604, the model trainer 116 performs an iterative optimization technique using the multiple initializations to generate multiple optimization results. Any suitable iterative optimization technique can be performed, such as the one of the techniques described above in conjunction with FIG. 5.

At step 606, the model trainer 116 computes a reward based on the multiple optimization results. In some embodiments, the reward can be computed according to equation (4), described above in conjunction with FIG. 5.

At step 608, the model trainer 116 updates parameters of the initialization model 150 based on the reward. In some embodiments, the parameters of the initialization model 150 can be updated via backpropagation and gradient descent, with the gradient being computed according to equation (5), described above in conjunction with FIG. 5.

At step 610, if the model trainer 116 determines to stop training, then the method 600 ends. For example, in some embodiments, the model trainer 116 can determine to stop training if a performance of the initialization model 150 does not improve for a number of training iterations, if a maximum number of training iterations have been performed, etc.

On the other hand, if the model trainer 116 determines to continue training, then the method 600 returns to step 602, where the model trainer 116 again generates multiple initializations using the initialization model 150 during training of the initialization model 150.

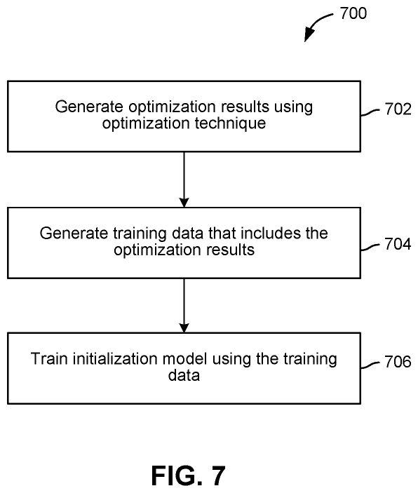

FIG. 7 is a flow diagram of method steps for training an initialization

model via supervised learning, according to various embodiments. Although the method steps are described in conjunction with the systems of FIGS. 1-5, persons skilled in the art will understand that any system configured to perform the method steps in any order falls within the scope of the present embodiments.

As shown, a method 700 begins at step 702, where the model trainer 116 generates optimization results using an iterative optimization technique. Similar to step 604 of the method 600, described above in conjunction with FIG. 6, any suitable iterative optimization technique, such one of the techniques described above in conjunction with FIG. 5, can be performed at step 702. In some embodiments, the iterative optimization technique that is performed at step 702 can be a slower and/or more accurate technique than the iterative optimization technique performed at step 604 of the method 600, described above in conjunction with FIG. 6. For example, in some embodiments, the iterative optimization technique can be performed offline at step 702, as opposed to in real time, and/or the iterative optimization technique can be performed for a relatively long period of time.

At step 704, the model trainer 116 generates training data that includes the optimization results. In some embodiments, the optimization results are included in the training data as the ground truth for training the initialization model 150. Returning to the autonomous vehicle example, the optimization results generated at step 702 can include trajectories of the autonomous vehicle. Assume the initialization model 150 generates initializations in the form of control sequences for controlling the autonomous vehicle. In such a case, the control sequences generated by the initialization model 150 can be input into an iterative optimization technique that outputs optimized control sequences. Then, the optimized control sequences can be input into a dynamics model to obtain trajectories of the autonomous vehicle, which can be compared with the trajectories from the training data to derive a loss that is backpropagated to update parameters of the initialization model 150. The dynamics model defines what the states would be if the optimized control sequences were executed, and the dynamics model can be used to define a cost/loss over vehicle states and not only vehicle controls. A dynamics model is needed in applications where the optimization problem is a control problem for a dynamic system, and the cost is a function of state.

At step 706, the model trainer 116 trains the initialization model 150 using the training data generated at step 704. In some embodiments, the training can be performed in a manner that promotes mode diversity so that the trained initialization model 150 is capable of generating multiple different initializations. For example, in some embodiments, the training can employ a loss function that includes a loss term for the average distance between all pairs of output modes. As another example, in some embodiments, the training can maximize a likelihood for a best predicted training mode under which the ground-truth optimization result has the highest likelihood, as described above in conjunction with FIG. 5.

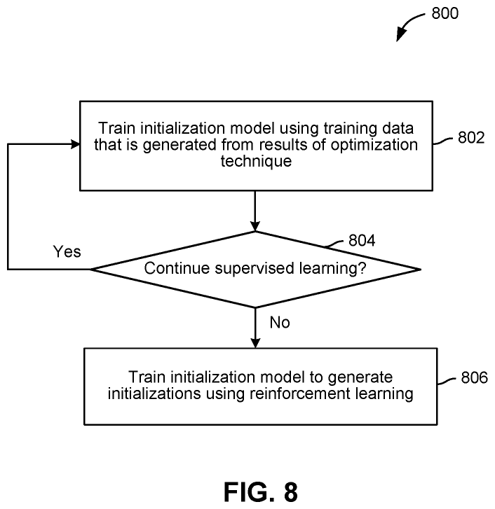

FIG. 8 is a flow diagram of method steps for training an initialization model via a combination of supervised learning and reinforcement learning, according to various embodiments. Although the method steps are described in conjunction with the systems of FIGS. 1-5, persons skilled in the art will understand that any system configured to perform the method steps in any order falls within the scope of the present embodiments.

As shown, a method 800 begins at step 802, where the model trainer 116 trains the initialization model 150 using training data that is generated from the results of an iterative optimization technique. In some embodiments, step 802 can include generating optimization results to include in training data using an iterative optimization technique and training the initialization model via supervised learning using the training data, according to the method 700 described above in conjunction with FIG. 7.

At step 804, if the model trainer 116 determines to continue the supervised learning, then the method 800 returns to step 802, where the model trainer 116 continues training the initialization model 150 using training data that is generated from the results of the iterative optimization technique. In some embodiments, the supervised learning can be used to initialize the initialization model 150, after which reinforcement learning is performed to further train the initialization model 150. For example, in some embodiments, supervised learning can be performed for a number of iterations or until predefined criteria are satisfied.

On the other hand, if the model trainer 116 determines to not continue the supervised learning, then the method 800 continues to step 806, where the model trainer 116 trains the initialization model 150 to generate initializations using reinforcement learning. In some embodiments, step 806 can include iteratively generating multiple initializations using the initialization model 150, performing an iterative optimization technique using the multiple initializations to generate multiple optimization results, computing a reward based on the multiple optimization results, and updating parameters of the initialization model 150 based on the reward, according to the method 600 described above in conjunction with FIG. 6.

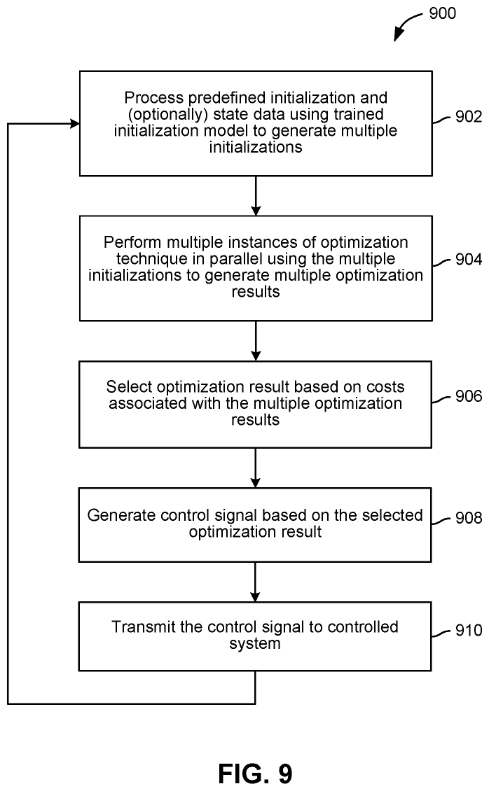

FIG. 9 is a flow diagram of method steps for generating a control signal using a trained initialization model, according to various embodiments. Although the method steps are described in conjunction with the systems of FIGS. 1-5, persons skilled in the art will understand that any system configured to perform the method steps in any order falls within the scope of the present embodiments.

As shown, a method 900 begins at step 902, where the control application 146 processes a predefined initialization and (optionally) state data using the trained initialization model 150 to generate multiple initializations. Any technically feasible predefined initialization and (optional) state data can be input into the trained initialization model 150, and the particular initialization and state data that is used will depend on what the initialization model 150 is trained to take as input. Returning to the autonomous vehicle example, in some embodiments, the predefined initialization can be a previous optimization result, such as a previous control action generated via the MPC technique, and the state data can include velocity, acceleration, position, steering wheel status, etc. data that is acquired via one or more sensors (e.g., sensors 180).

At step 904, the control application 146 performs multiple instances of an iterative optimization technique in parallel using the multiple initializations to generate multiple optimization results. Any technically feasible iterative optimization technique, such as one of the techniques described above in conjunction with FIG. 5, can be performed in some embodiments.

At step 906, the control application 146 selects one of the multiple optimization results based on costs associated with the multiple optimization results. Any technically feasible costs associated with the optimization results can be used in some embodiments. For example, in some embodiments, the costs can be costs that the multiple instances of the iterative optimization technique attempted to minimize at step 904. As another example, in some embodiments, the costs can be computed separately from the multiple instances of the iterative optimization technique at step 904.

At step 908, the control application 146 generates a control signal based on the selected optimization result. Any suitable control signal can be generated in some embodiments. For example, in the case of an autonomous vehicle example, the control signal can include one or more signals to control steering, acceleration, etc. of the vehicle. As another example, in the case of a robot, the control signal can include a signal to a joint controller of the robot.

At step 910, the control application 146 transmits the control signal to a system being controlled (e.g., controlled system 142). For example, in some embodiments, the system being controlled can be an autonomous vehicle, a robot, a power plant, etc.

In sum, techniques are disclosed for generating initializations for parallel optimizers. In some embodiments, a control application generates multiple initializations for an iterative optimization technique using a trained initialization model. The initialization model is a machine learning model that is trained to generate initializations for initializing the iterative optimization technique. The control application performs multiple instances of the iterative optimization technique in parallel, beginning from the multiple initializations, to generate multiple optimization results. Then, the control application computes a cost associated with each of the multiple optimization results, and the control application selects one of the optimization results based on the computed costs. Thereafter, the control application generates a control signal from the selected optimization result, and the control application transmits the control signal to control a system, such as an autonomous vehicle, a robot, a power plant, or the like.

In some embodiments, the initialization model can be trained via reinforcement learning, supervised learning, or a combination thereof. During reinforcement learning, the initialization model is used to generate initializations, an iterative optimization technique is performed using the initializations to generate optimization results, a reward is computed based on the optimization results, and parameters of the initialization model are updated based on the reward. During supervised learning, an iterative optimization technique is used to generate optimization results, and the optimization results are included in training data that is used to train the initialization model. During the combination of supervised and reinforcement learning, the initialization model is first trained using supervised learning to initialize the initialization model, and the training of the initialization model then switches to reinforcement learning.

At least one technical advantage of the disclosed techniques relative to the prior art is that the disclosed techniques generate multiple initializations that can be used to initialize multiple optimizers that execute in parallel. The multiple optimizers generate multiple optimization results, where one or more of those optimization results are typically improved relative to the optimization result generated by a single optimizer that is initialized using prior art approaches. Further, at least one of the improved optimization results can be selected to generate a control signal for controlling an autonomous vehicle, robot, power plant, or other system in a more correct manner relative to a control signal that can typically be generated using the optimization result of a single optimizer. These technical advantages represent one or more technological improvements over prior art approaches.
1. In some embodiments, a computer-implemented method for controlling a system comprises generating a plurality of initializations using a trained machine learning model, performing a plurality of instances of an iterative technique based on the plurality of initializations to generate a plurality of results, generating a control signal based on one or more results included in the plurality of results, and transmitting the control signal to the system to cause the system to perform one or more operations.
2. The computer-implemented method of clause 1, further comprising computing a plurality of costs associated with the plurality of results, and selecting a first result from the plurality of results based on the plurality of costs, wherein the control signal is generated based on the first result.
3. The computer-implemented method of clauses 1 or 2, wherein the plurality of initializations is generated by processing a first initialization and state data using the trained machine learning model.
4. The computer-implemented method of any of clauses 1-3, wherein the plurality of instances of the iterative technique are performed in parallel via at least one parallel processing unit.
5. The computer-implemented method of any of clauses 1-4, further comprising performing one or more instances of another iterative technique to generate a plurality of other results, and performing one or more operations to train the trained machine learning model based on training data that includes the plurality of other results.
6. The computer-implemented method of any of clauses 1-5, further comprising performing one or more reinforcement learning operations to train the trained machine learning model based on one or more rewards associated with one or more results generated while training the trained machine learning model.
7. The computer-implemented method of any of clauses 1-6, further comprising performing one or more supervised learning operations and one or more reinforcement learning operations to train the trained machine learning model.
8. The computer-implemented method of any of clauses 1-7, wherein the iterative technique comprises at least one of a model predictive control (MPC) technique, a linear quadratic regulator (LQR) technique, a gradient descent technique, a quasi-Newton method technique, an interior point technique, or a Sequential Quadratic Programming technique.
9. The computer-implemented method of any of clauses 1-8, wherein the trained machine learning model comprises a Gaussian mixture model or a conditional variational autoencoder.
10. The computer-implemented method of any of clauses 1-9, wherein the system comprises an autonomous vehicle, a robot, or a power plant.
11. In some embodiments, one or more non-transitory computer-readable media store instructions that, when executed by at least one processor, cause the at least one processor to perform the steps of generating a plurality of initializations using a trained machine learning model, performing a plurality of instances of an iterative technique based on the plurality of initializations to generate a plurality of results, generating a control signal based on one or more results included in the plurality of results, and transmitting the control signal to a system to cause the system to perform one or more operations.
12. The one or more non-transitory computer-readable media of clause 11, wherein the instructions, when executed by the at least one processor, further cause the at least one processor to perform the steps of computing a plurality of costs associated with the plurality of results, and selecting a first result from the plurality of results based on the plurality of costs, wherein the control signal is generated based on the first result.
13. The one or more non-transitory computer-readable media of clauses 11 or 12, wherein the plurality of initializations is generated by processing a first initialization and state data using the trained machine learning model.
14. The one or more non-transitory computer-readable media of any of clauses 11-13, wherein the plurality of instances of the iterative technique are performed in parallel via at least one parallel processing unit.
15. The one or more non-transitory computer-readable media of any of clauses 11-14, wherein the instructions, when executed by the at least one processor, further cause the at least one processor to perform the steps of performing one or more instances of another iterative technique to generate a plurality of other results, and performing one or more operations to train the trained machine learning model based on training data that includes the plurality of other results.
16. The one or more non-transitory computer-readable media of any of clauses 11-15, wherein the instructions, when executed by the at least one processor, further cause the at least one processor to perform the step of performing one or more reinforcement learning operations to train the trained machine learning model based on one or more rewards associated with one or more results generated while training the trained machine learning model.
17. The one or more non-transitory computer-readable media of any of clauses 11-16, wherein the instructions, when executed by the at least one processor, further cause the at least one processor to perform the step of performing one or more supervised learning operations followed by one or more reinforcement learning operations to train the trained machine learning model.
18. The one or more non-transitory computer-readable media of any of clauses 11-17, wherein the trained machine learning model comprises a neural network.
19. The one or more non-transitory computer-readable media of any of clauses 11-18, wherein the control signal comprises at least one of a steering signal, an acceleration signal, or a signal to one or more joint controllers of a robot.
20. In some embodiments, a system comprises one or more memories storing instructions, and one or more processors that are coupled to the one or more memories and, when executing the instructions, are configured to generate a plurality of initializations using a trained machine learning model, perform a plurality of instances of an iterative technique based on the plurality of initializations to generate a plurality of results, generate a control signal based on one or more results included in the plurality of results, and transmit the control signal to a controlled system to cause the controlled system to perform one or more operations.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling a system, the method comprising:
generating a plurality of initializations using a trained machine learning model;
performing a plurality of instances of an iterative technique based on the plurality of initializations to generate a plurality of results;
generating a control signal based on one or more results included in the plurality of results; and
transmitting the control signal to the system to cause the system to perform one or more operations.

2. The computer-implemented method of claim 1, further comprising:
computing a plurality of costs associated with the plurality of results; and
selecting a first result from the plurality of results based on the plurality of costs,
wherein the control signal is generated based on the first result.

3. The computer-implemented method of claim 1, wherein the plurality of initializations is generated by processing a first initialization and state data using the trained machine learning model.

4. The computer-implemented method of claim 1, wherein the plurality of instances of the iterative technique are performed in parallel via at least one parallel processing unit.

5. The computer-implemented method of claim 1, further comprising:
performing one or more instances of another iterative technique to generate a plurality of other results; and
performing one or more operations to train the trained machine learning model based on training data that includes the plurality of other results.

6. The computer-implemented method of claim 1, further comprising performing one or more reinforcement learning operations to train the trained machine learning model based on one or more rewards associated with one or more results generated while training the trained machine learning model.

7. The computer-implemented method of claim 1, further comprising performing one or more supervised learning operations and one or more reinforcement learning operations to train the trained machine learning model.

8. The computer-implemented method of claim 1, wherein the iterative technique comprises at least one of a model predictive control (MPC) technique, a linear quadratic regulator (LQR) technique, a gradient descent technique, a quasi-Newton method technique, an interior point technique, or a Sequential Quadratic Programming technique.

9. The computer-implemented method of claim 1, wherein the trained machine learning model comprises a Gaussian mixture model or a conditional variational autoencoder.

10. The computer-implemented method of claim 1, wherein the system comprises an autonomous vehicle, a robot, or a power plant.

11. One or more non-transitory computer-readable media storing instructions that, when executed by at least one processor, cause the at least one processor to perform the steps of:
generating a plurality of initializations using a trained machine learning model;
performing a plurality of instances of an iterative technique based on the plurality of initializations to generate a plurality of results;
generating a control signal based on one or more results included in the plurality of results; and
transmitting the control signal to a system to cause the system to perform one or more operations.

12. The one or more non-transitory computer-readable media of claim 11, wherein the instructions, when executed by the at least one processor, further cause the at least one processor to perform the steps of
computing a plurality of costs associated with the plurality of results; and
selecting a first result from the plurality of results based on the plurality of costs,
wherein the control signal is generated based on the first result.

13. The one or more non-transitory computer-readable media of claim 11, wherein the plurality of initializations is generated by processing a first initialization and state data using the trained machine learning model.

14. The one or more non-transitory computer-readable media of claim 11, wherein the plurality of instances of the iterative technique are performed in parallel via at least one parallel processing unit.

15. The one or more non-transitory computer-readable media of claim 11, wherein the instructions, when executed by the at least one processor, further cause the at least one processor to perform the steps of:
performing one or more instances of another iterative technique to generate a plurality of other results; and
performing one or more operations to train the trained machine learning model based on training data that includes the plurality of other results.

16. The one or more non-transitory computer-readable media of claim 11, wherein the instructions, when executed by the at least one processor, further cause the at least one processor to perform the step of performing one or more reinforcement learning operations to train the trained machine learning model based on one or more rewards associated with one or more results generated while training the trained machine learning model.

17. The one or more non-transitory computer-readable media of claim 11, wherein the instructions, when executed by the at least one processor, further cause the at least one processor to perform the step of performing one or more supervised learning operations followed by one or more reinforcement learning operations to train the trained machine learning model.

18. The one or more non-transitory computer-readable media of claim 11, wherein the trained machine learning model comprises a neural network.

19. The one or more non-transitory computer-readable media of claim 11, wherein the control signal comprises at least one of a steering signal, an acceleration signal, or a signal to one or more joint controllers of a robot.

20. A system, comprising:
one or more memories storing instructions; and
one or more processors that are coupled to the one or more memories and, when executing the instructions, are configured to:
generate a plurality of initializations using a trained machine learning model,
perform a plurality of instances of an iterative technique based on the plurality of initializations to generate a plurality of results,
generate a control signal based on one or more results included in the plurality of results, and
transmit the control signal to a controlled system to cause the controlled system to perform one or more operations.
